(19) United States
(12) Patent Application Publication
(10) Pub. No.: US 2025/0013558 A1
(43) Pub. Date: Jan. 9, 2025

(54) METHOD, APPARATUS, DEVICE, AND MEDIUM FOR MODIFYING A BYTECODE

(71) Applicant: Lemon Inc., Grand Cayman (KY)

(72) Inventor: Junyu YUE, Beijing (CN)

(21) Appl. No.: 18/762,525

(22) Filed: Jul. 2, 2024

(30) Foreign Application Priority Data
Jul. 4, 2023 (CN) 202310815464.7

(51) Int. Cl. G06F 11/36

(52) U.S. Cl. CPC G06F 11/3624

(57) ABSTRACT

The disclosure provides a method, apparatus, device, and medium for modifying a bytecode. The detailed description of the method includes: searching for a bytecode to be tested based on a predetermined annotation and determining a depended object category and a depending object category for dependency injection therefrom; and generating a supplementary bytecode based on the depended object category, inserting the supplementary bytecode into a corresponding part of the depending object category in the bytecode to be tested to obtain a target bytecode. With this method, static dependency injection of code can be implemented in the compilation phase with only a few source code modifications, especially without the need to write a large amount of template code, and the success of the code after dependency injection is guaranteed in the software runtime phase.

### CROSS-REFERENCE TO RELATED APPLICATION

This application claims priority to Chinese patent application No. 202310815464.7, filed on Jul. 4, 2023 and entitled “A METHOD, APPARATUS, DEVICE, AND MEDIUM FOR MODIFYING A BYTECODE”, which is incorporated herein by reference in its entirety.

### FIELD

This disclosure relates to the field of code compilation technology, particularly to a method, apparatus, device, and medium for modifying a bytecode.

### BACKGROUND

During software development, the dependency relationships between different object types in software code are often complex. Complex dependency relationships can lead to a decrease in the scalability of software code, while also making maintenance and modification of the code more difficult. The existing dependency injection schemes can be used to decouple dependencies between different object categories, thereby improving code scalability and facilitating code maintenance and modification. However, existing dependency injection schemes may have significant modifications to the source code, such as the need to write a large amount of template code, or the problem of dependency injection code not actually succeeding in the software stage after code compilation.

### SUMMARY

This disclosure describes a method, apparatus, device, and medium for modifying a bytecode.

According to a first aspect, a method of modifying a bytecode is provided, comprising:
searching for a bytecode to be tested based on a predetermined annotation, and determining a depended object category and a depending object category for dependency injection therefrom; and
generating a supplementary bytecode based on the depended object category, inserting the supplementary bytecode into a corresponding part of the depending object category in the bytecode to be tested to obtain a target bytecode.

According to a second aspect, an apparatus for modifying a bytecode is provided, comprising:
a dependency determining unit configured to search for a bytecode to be tested based on a predetermined annotation, and determine a depended object category and a depending object category for dependency injection therefrom; and
a modifying unit configured to generate a supplementary bytecode based on the depended object category, insert the supplementary bytecode into a corresponding part of the depending object category in the bytecode to be tested to obtain a target bytecode.

According to a third aspect, a computer-readable storage medium having a computer program stored thereon is provided, the computer program, when executed in a computer, causing the computer to execute the method of the first aspect.

According to a fourth aspect, an electronic device comprising a memory and a processor is provided, the memory storing an executable code therein, the executable code, when executed by the processor, implementing the method of the first aspect.

A method, apparatus, device, and medium for modifying a bytecode are provided according to the embodiments of the present disclosure. It is possible to search for a bytecode to be tested based on a predetermined annotation and determine a depended object category and a depending object category for dependency injection therefrom. Then, a supplementary bytecode is generated based on the depended object category, the supplementary bytecode is inserted into a corresponding part of the depending object category in the bytecode to be tested to obtain a target bytecode. With any of the above methods, apparatuses, storage media, and electronic devices, static dependency injection of code can be implemented during the compilation phase with only a small amount of source code modification, especially without the need to write a large amount of template code, ensuring the successful operation of the injected code during the software runtime.

### BRIEF DESCRIPTION OF THE DRAWINGS

FIG. 1 shows a schematic diagram of a dependency injection scheme;

FIG. 2 shows a schematic diagram of another dependency injection scheme;

FIG. 3 shows a schematic flowchart of a method of modifying a bytecode according to an embodiment of the present disclosure;

FIG. 4 shows a schematic diagram of a depended object category in a bytecode according to an embodiment of the present disclosure;

FIG. 5 shows a schematic diagram of a depending object category in a bytecode according to an embodiment of the present disclosure;

FIGS. 6(a) and 6(b) show schematic diagrams of a source code corresponding to dependency injection according to an embodiment of the present disclosure;

FIG. 7 shows a schematic diagram of a modified bytecode according to an embodiment of the present disclosure;

FIG. 8 shows a schematic block diagram of an apparatus for modifying a bytecode according to the embodiments of the present disclosure;

FIG. 9 shows a structural schematic diagram of an electronic device suitable for use in implementing an embodiment of the present disclosure;

FIG. 10 shows a structural schematic diagram of a storage medium suitable for use in implementing an embodiment of the present disclosure.

### DETAILED DESCRIPTION

The technical solutions provided herein are described in further detail below in connection with the accompanying drawings and embodiments. It is to be understood that the specific embodiments described herein are only for explaining the invention in question and are not a limitation of the invention. It is also to be noted that, for ease of description, only the portions related to the relevant invention are shown in the accompanying drawings. It is to be noted that the embodiments and features in the embodiments of the present disclosure may be combined with each other without conflict.

In the description of the embodiments of the present disclosure, the term “comprising” and its analogues should be understood as open-ended inclusion, i.e., “comprising but not limited to”. The term “based on” is to be understood as “at least partially based on”. The terms “a/an implementation” or “the implementation” are to be understood as “at least one/an implementation”. The term “some implementations” should be understood as “at least some implementations”. Other definitions, both explicit and implicit, may be comprised below.

During software development, the dependency relationships between different object types in software code are often complex. Complex dependency relationships can lead to a decrease in the scalability of software code, while also making maintenance and modification of the code more difficult. The existing dependency injection schemes can be used to decouple dependencies between different object categories, thereby improving code scalability and facilitating code maintenance and modification. Specifically, the Dependency Injection (DI) scheme can decouple the dependencies between different depending object categories (or consumer objects) and depended object categories (or production objects), where the depending object categories are not involved in the construction of the depended object categories on which they depend, and the depended object category does not have information about the object categories on which it is dependent. The binding of specific dependencies between these categories is done through the dependency injection framework.

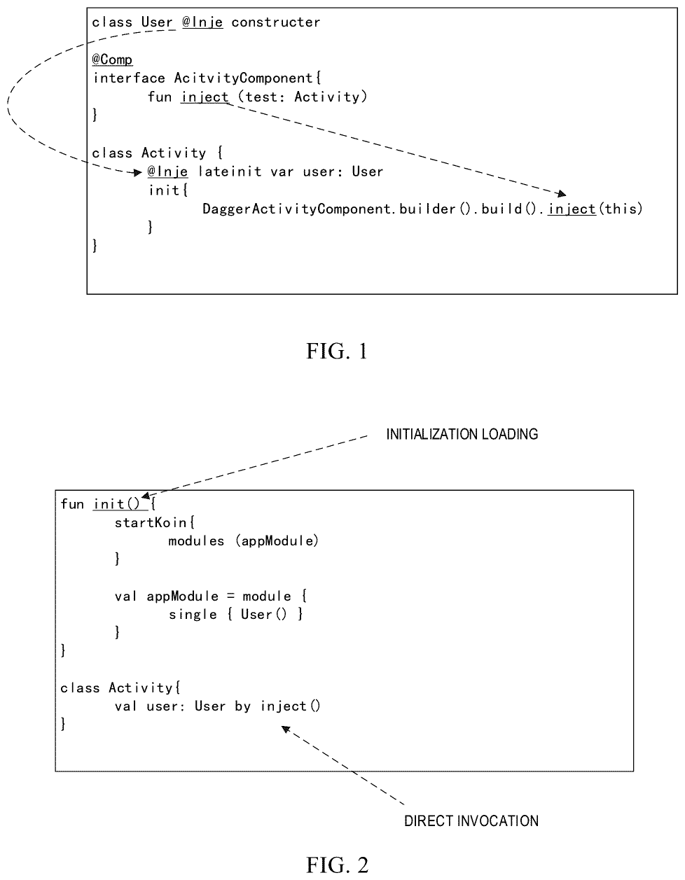

However, existing dependency injection schemes usually suffer from a high number of modifications to the source code, such as the problem of writing large amounts of boilerplate code. Or there is the problem that the dependency injected code does not actually succeed in the software phase after the code is compiled. For example, one dependency injection scheme implements dependency injection through predetermined code templates. FIG. 1 shows a schematic diagram of a dependency injection scheme, as shown in FIG. 1, which implements dependency injection by means of code templates as follows: e.g., the @Inje annotation is used to label the depended object category, e.g., the @Comp annotation is used to label a specific interface to be implemented by the depending object category, and the depended object category (e.g., Activity) is required to present a framework function provided by the invocation template, e.g. DaggerActivityComponent.builder( ).build( ).inject(this), to implement the above specific interface. However, compared with the non-dependency injection scenario, the definition of the specific interface and the invocation of the feature framework function to implement the specific interface in this scenario not only require more extra code to be written in the source code, but also the coding style is different from the conventional coding style in the non-dependency injection scenario, which makes it more difficult to write and maintain the code. Another dependency injection scheme is to dynamically perform dependency injection during the runtime of the software. FIG. 2 shows a schematic diagram of another dependency injection scheme. As shown in FIG. 2, the scheme may, for example, load the depending object category and the depended object category at the initialization of the application run, and find the depended object category required for the depending object category and inject it at runtime by means of the dependency injection framework. However, because the finding of the depended object category on which the depending object category depends is performed at runtime, the code objects of the depended object category cannot be statically injected into the depending object category at the software compilation period. This can lead to the problem that dependency injection does not actually succeed at runtime after the code has been compiled, for example, because a specific depended object category has not actually been constructed, and the depending object category cannot be found.

In order to solve the above technical problems, embodiments of the present disclosure provide a method of modifying a bytecode. In some embodiments, a depended object category and a depending object category may be labelled by a predetermined annotation in advance in a target source code, and in a bytecode to be tested obtained by compilation of the target source code, an annotation corresponding to the predetermined annotation is searched for, and the depended object category and the depending object category used in the bytecode to be tested are determined based on the searched for annotation. Then, a supplementary bytecode is generated based on the depended object category, and the supplementary bytecode is inserted into the interior of the depending object category in the bytecode to be tested to obtain a target bytecode. The advantage of this method is that, on the one hand, compared to the scheme of implementing dependency injection through a code template, for the user, dependency injection can be implemented by adding only a small number of annotations in the source code, and there is no need to write more additional template code, e.g., the depending object category does not need to implement a specific interface, or invoke a specific framework function to implement the specific interface. As a result, the difficulty of writing and maintaining code is greatly reduced. On the other hand, relative to the scheme of performing dynamic dependency injection at the runtime, the target bytecode is obtained by modifying the bytecode to be tested obtained by compiling based on the source code, for example, by inserting the bytecode for constructing the depending object category into the depending object category in the bytecode to be tested. Further, an object instance of the depending object category can be constructed in the runtime phase directly from the bytecode inserted in the depending object category, i.e., the problem of not being able to find the depended object category does not occur in the runtime phase. The modification of bytecode to be tested can also be carried out in the compilation phase, so that if the code can be compiled and passed, the dependency injection can actually succeed. This prevents the problem of dependency injection not actually succeeding during the software runtime after the code has been compiled and passed.

The details of the method are described further below.

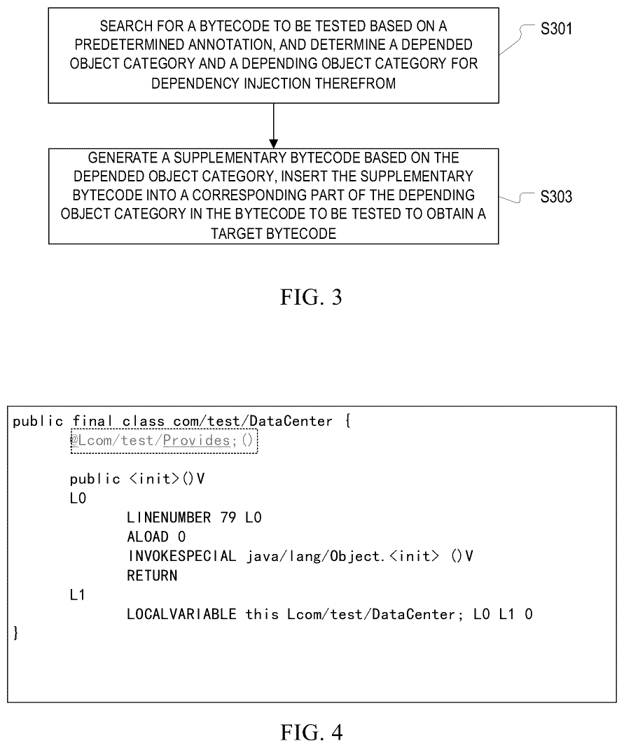

FIG. 3 shows a schematic flowchart of a method of modifying a bytecode according to an embodiment of the present disclosure. As shown in FIG. 3, the method comprises at least the following steps.

At Step S301, a bytecode to be tested is searched based on a predetermined annotation, and a depended object category and a depending object category are determined for dependency injection therefrom.

At Step S303, a supplementary bytecode is generated based on the depended object category, the supplementary bytecode is inserted into a corresponding part of the depending object category in the bytecode to be tested to obtain a target bytecode.

Firstly, at step S301, a bytecode to be tested is searched based on a predetermined annotation, and a depended object category and a depending object category are determined for dependency injection therefrom. In different embodiments, the bytecode to be tested may be bytecode compiled according to different software products or applications, or source code for different specific purposes. In different embodiments, the bytecode to be tested may also be different specific types of bytecode, which may be obtained by compiling source code written in different programming languages through compilers or interpreters corresponding to different coding languages, and the present specification does not restrict this. In one embodiment, the bytecode to be tested may be Java bytecode, which may be obtained by compiling source code written in, for example, the Java language or the Kotlin language. In another embodiment, the bytecode to be tested may be Low Level Virtual Machine Intermediate Representation LLVM IR (Low Level Virtual Machine Intermediate Representation), which may be obtained by compiling source code written in, for example, the C++ language or the Objective C language.

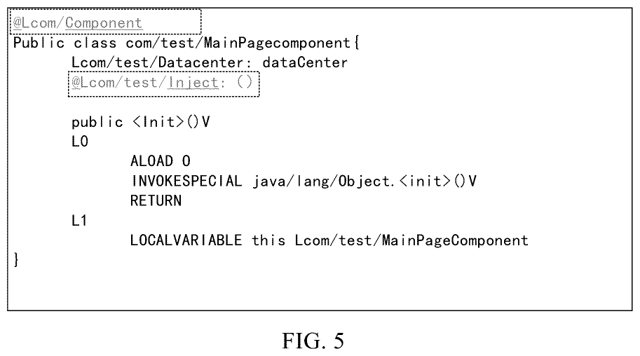

Annotations can be special labels in different types of code (e.g., source code, or bytecode compiled from source code), which can be read at compile, load, and run time of different types of code and processed accordingly. The annotations allow embedding supplementary information in the code without changing the original code and logic. In different embodiments, the specific way of searching for bytecode to be tested can be different, and this specification does not limit this. The predetermined annotation may be used to recognize the injection of dependency relationships in the bytecode to be tested, specifically, for example, it may be used to label the depended object category and the depending object category in the dependency injection relationship. Here, the depended object category and the depending object category may refer to a category (or class) of program objects, which are encapsulators of data structures and algorithms, and program objects belonging to the same class may share attributes and functions of that program class. In one embodiment, the predetermined annotation may comprise a first predetermined annotation and a second predetermined annotation for labelling the depended object category and the depending object category in the bytecode to be tested, respectively. Thereby, the depended object category for dependency injection can be determined from the plurality of object categories included in the bytecode to be tested according to the first predetermined annotation; and the depending object category for dependency injection can be determined from the plurality of object categories included in the bytecode to be tested according to the second predetermined annotation. In the above manner, the depending object categories and the depended object categories in the bytecode to be tested can be quickly determined by searching the predetermined annotation. For example, FIG. 4 shows a schematic diagram of a depended object category in a bytecode according to an embodiment of the present disclosure. As shown in FIG. 4, the DataCenter class can be quickly determined to be a class of the depended object category in the dependency injection based on the annotation “@Lcom/test/Provides” in the DataCenter class (class). FIG. 4 shows a schematic diagram of the depended object category in a bytecode according to embodiments of the present disclosure. As shown in FIG. 5, the MainPagecomponent class can be quickly determined to be the class of the depending object category in the dependency injection relationship based on the annotation “_@Lcom/Component” in the MainPagecomponent class. The depended object category may specifically be injected with an attribute or member variable in the depending object category. Thus, in one embodiment, the predetermined annotation may also comprise a third predetermined annotation for specifying the Attribute, or Member Variables, to which the dependency injection points in the depending object category. By searching for the third predetermined annotation, the specific attribute or member variable of the depending object category to which the dependency injection refers can be quickly determined. As shown in FIG. 5, for example, the dataCenter attribute can be quickly determined to be the specific attribute being injected based on the annotation “_@Lcom/test/Inject”.

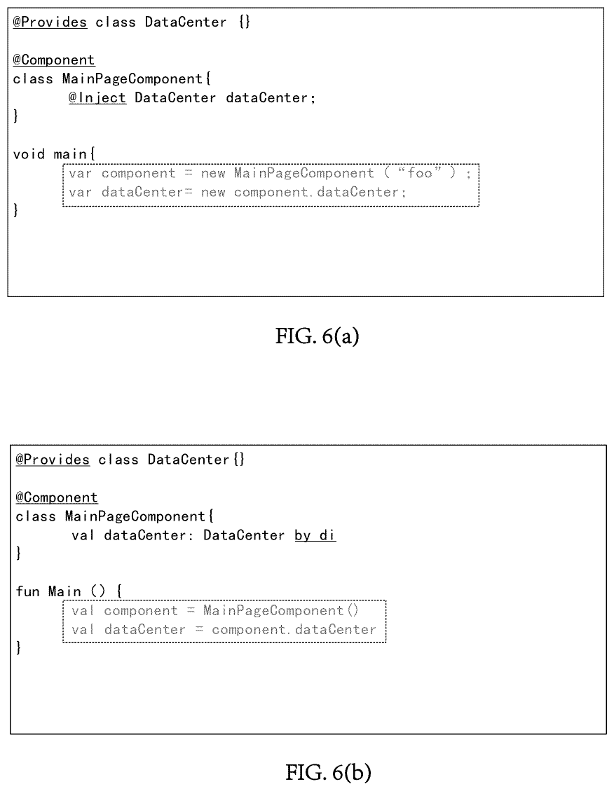

As described above, in various embodiments, the bytecode to be tested may be bytecode obtained by compiling source code according to different software products or applications, or for different specific purposes. In one embodiment, the bytecode to be tested may for example be obtained by compiling the target source code. In order to obtain bytecode to be tested by compilation including predetermined annotations, in one embodiment the target source code may include an annotation corresponding to the predetermined annotation. FIGS. 6 (a) and 6 (b) show schematic diagrams of source code corresponding to dependency injection according to an embodiment of the present disclosure. As in the example shown in FIG. 6 (a), a depended class (e.g., DataCenter) in the target source code is labelled, for example, by the annotation @Provides, a depending class (e.g., MainPagecomponent) is labelled, for example, by the annotation @Component, and an attribute of the dependency injection in the depending class (e.g., dataCenter) is labelled, for example, by the annotation @ Inject tag. As can be seen, these annotations in the target source code and the intended annotations in the bytecode to be tested correspond to each other. Therefore, it is possible to compile the target source code containing these annotations to obtain the bytecode to be tested in which the intended annotations are labelled. In various embodiments, based on the programming statements of the target source code, the attributes of a dependency injection (e.g., dataCenter) in a depending class may also be specified in other ways. For example, in an embodiment where the programming statements of the target source code support an attribute proxy feature, the attribute for dependency injection may also be specified via an attribute proxy. For example, in the example shown in FIG. 6(b), an attribute of a dependency class in a depending class can be specified by an attribute proxy expression “by di”, for example. From the examples in FIG. 6(a) and FIG. 6(b), the use of the depended and depending object categories in e.g. the main{ } function is the same as in the case of non-dependency injection. In other words, this approach improves the coding experience of the user as the modification of the bytecode can be implemented automatically, and the user perceives that the dependency injection can be implemented with only a few modifications to the source code under the non-dependency injection.

Then, at step S303, a supplementary bytecode is generated based on the depended object category, the supplementary bytecode is inserted into a corresponding part of the depending object category in the bytecode to be tested to obtain a target bytecode. In this step, a corresponding bytecode (i.e., a supplementary bytecode) may be generated based on the depended object category, and the bytecode may be inserted into the depending object category within the bytecode to be tested to obtain the target bytecode. In one embodiment, specifically, the supplementary bytecode may be inserted into a constructor of the dependent object category such that any object instance of the depending object category executes the supplementary bytecode at the time of construction.

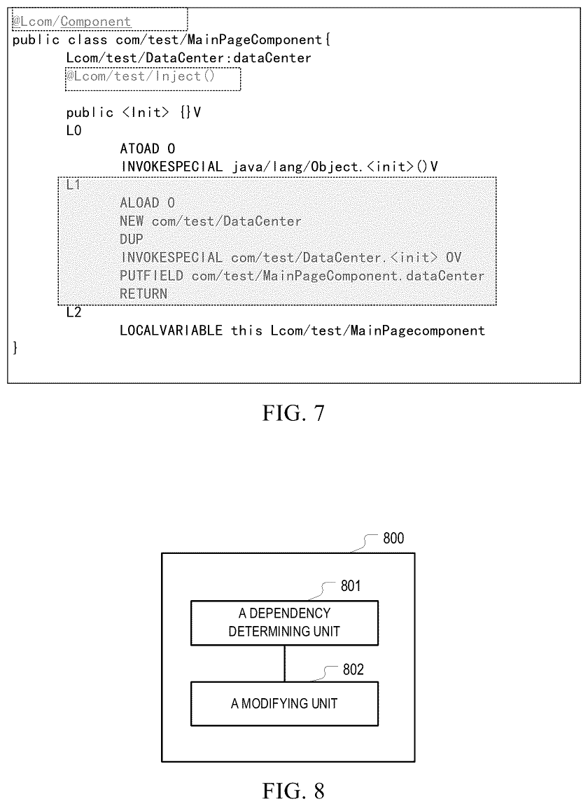

As previously mentioned, in different embodiments, the bytecode to be tested may be a different specific type of bytecode. It will be appreciated that in different embodiments, the supplementary bytecode generated based on the depended object category may also be bytecode of different specific types. In one embodiment, the supplementary bytecode may be used to perform the following operations: constructing an object instance of the depended object category and assigning the object instance to an attribute of the depending object category. The specific way in which the supplementary bytecode is written may vary in different specific embodiments. FIG. 7 shows a schematic diagram of a modified bytecode according to an embodiment of the present disclosure. As shown in FIG. 7, the supplementary bytecode may be, for example, a block of L1 bytecode inserted in the constructor of the MainPageComponent class. In the above manner, the depending object in the target bytecode obtained in the compilation phase thus contain bytecode for constructing object instances of the depended object category, so that as long as the compilation passes, the dependency injection can be successful and there is no problem of not finding the depended object category at runtime.

FIG. 8 shows a schematic block diagram of an apparatus for modifying a bytecode according to the embodiments of the present disclosure. The apparatus is used to execute the method shown in FIG. 3. As shown in FIG. 8, the apparatus 800 comprises:
a dependency determining unit 801 configured to search for a bytecode to be tested based on a predetermined annotation, and determine a depended object category and a depending object category for dependency injection therefrom; and
a modifying unit 802 configured to generate a supplementary bytecode based on the depended object category, insert the supplementary bytecode into a corresponding part of the depending object category in the bytecode to be tested to obtain a target bytecode.

This disclosure also provides an electronic device comprising a memory and a processor, the memory storing an executable code therein, the executable code, when executed by the processor, implementing the method shown in FIG. 3.

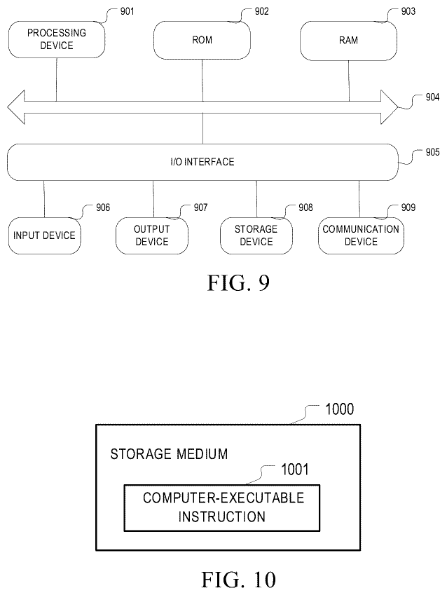

The following can also refer to FIG. 9, which shows a structural schematic diagram of an electronic device suitable for use in implementing an embodiment of the present disclosure. The electronic device 900 shown in FIG. 9 is only an example and should not impose any limitations on the functionality and scope of use of the embodiments of this application.

As shown in FIG. 9, the electronic device 900 may comprise a processing device (e.g., a central processing unit, a graphics processor, etc.) 901. The above-described processing device 901 may be a general purpose processor, a Digital Signal Processing (DSP), a microprocessor, or a microcontroller, and may further comprise an Application Specific Integrated Circuit (ASIC), a Field-Programmable Gate Array (FPGA), or other programmable logic device, discrete gate or transistor logic device, discrete hardware component, which may be based upon a read-only memory (ROM) 902 or loaded from storage device 908 into random access memory (RAM) 903 and perform various appropriate actions and processing. Also stored in the RAM 903 are various programs and data necessary for the operation of the electronic device 900. The processing device 901, the ROM 902, and the RAM 903 are connected to each other via a bus 904. An input/output (I/O) interface 905 is also connected to the bus 904.

Typically, the following devices may be connected to the I/O interface 905: an input device 906 comprising, for example, a touch screen, a touch pad, a keyboard, a mouse, and the like; an output device 907 comprising, for example, a liquid crystal display (LCD), a speaker, a vibrator, and the like; a storage device 908 comprising, for example, a magnetic tape, a hard drive, and the like; and a communication device 909. The communication device 909 may allow the electronic device 900 to communicate wirelessly or wiredly with other devices to exchange data. While FIG. 9 shows electronic device 900 with various devices, it should be understood that it is not required to implement or have all of the devices shown. More or fewer devices may alternatively be implemented or possessed. Each block shown in FIG. 9 may represent a single device or may represent a plurality of devices as desired.

In particular, according to embodiments of the present application, the process described above with reference to the flowchart may be implemented as a computer software program. For example, embodiments of the present application include a computer program product comprising a computer program carried on a computer readable medium, the computer program comprising program code for performing the method shown in the flowchart. In such embodiments, the computer program may be downloaded and installed from a network via the communication device 909, or from the storage device 908, or from the ROM 902. When this computer program is executed by the processing device 901, the above-described functions defined in the method for modifying the byte code provided in the embodiments of the present application are performed.

This disclosure also provides a computer-readable storage medium having a computer program stored thereon, the computer program, when executed in a computer, causing the computer to execute the method of modifying a bytecode as shown in FIG. 1 provided by embodiments of the present disclosure. FIG. 10 is a schematic diagram of a storage medium for implementing the embodiments of the present application. For example, as shown in FIG. 10, the storage medium 1000 may be a non-temporary computer-readable storage medium for storing the non-transitory computer-executable instructions 1001. The method of modifying a bytecode provided in the embodiments of the present application may be implemented when the non-transitory computer-executable instructions 1001 are executed by the processor, for example, one or more steps in the method of modifying a bytecode provided according to the embodiments of the present application may be performed when the non-transitory computer-executable instructions 1001 are executed by the processor. The storage medium 1000 may be applied in the electronic device described above, for example, the storage medium 1000 may comprise a memory in the electronic device. The description of the storage medium 1000 can be referred to the description of the memory in the embodiment of the electronic device, and the repetition will not be repeated. The specific functions and technical effects of the storage medium 1000 can be referred to the description of the modification method of the byte code provided in the embodiments of the present application and will not be repeated herein.

It should be noted that the computer-readable medium described in the embodiments disclosed herein can be a computer-readable signal medium, a computer-readable storage medium, or any combination of the above two. A computer-readable storage medium may be, but is not limited to, an electrical, magnetic, optical, electromagnetic, infrared, or semiconductor system, device, or device, or any combination thereof. More specific examples of computer-readable storage media may include, but are not limited to: electrical connections with one or more wires, storage cards for smartphones, storage components for tablets, portable computer disks, hard drives for personal computers, random access memory (RAM), read-only memory (ROM), erasable programmable read-only memory (EPROM or flash), fiber optics, portable compact disk read-only memory (CD-ROM), optical storage devices, magnetic storage devices, or any suitable combination of the above. In the embodiments disclosed herein, a computer-readable storage medium may be any tangible medium containing or storing a program, which may be used by an instruction execution system, device, or device, or in combination with it. In the embodiments disclosed herein, computer-readable signal media may include data signals propagated in the baseband or as part of the carrier wave, which carry computer-readable program code. This type of transmitted data signal can take various forms, including but not limited to electromagnetic signals, optical signals, or any suitable combination of the above. A computer-readable signal medium can also be any computer-readable medium other than a computer-readable storage medium, which can send, propagate, or transmit programs for use by instruction execution systems, devices, or devices, or in combination with them. The program code contained on computer-readable media can be transmitted using any appropriate medium, including but not limited to: wires, optical cables, RF (Radio Frequency), etc., or any suitable combination of the above.

The above-mentioned computer-readable medium may be included in the electronic device mentioned above; It can also exist separately without being assembled into the electronic device. The above-mentioned computer-readable medium carries one or more programs, which, when executed by the server, enable the electronic device to implement the modification method of the bytecode provided in the embodiments of the present application.

Computer program code for executing the operations of the embodiments of the present disclosure can be written in one or more programming languages or combinations thereof, including object-oriented programming languages such as Java, Smalltalk, C++, and conventional procedural programming languages such as C or similar programming languages. Program code can be completely executed on the user's computer, partially executed on the user's computer, executed as an independent software package, partially executed on the user's computer, partially executed on a remote computer, or completely executed on a remote computer or server. In cases involving remote computers, remote computers can connect to user computers through any type of network, including local area networks (LANs) or wide area networks (WANs), or can connect to external computers (such as using internet service providers to connect via the internet).

The flowchart and block diagram in the attached FIG. illustrate the possible architecture, functions, and operations of the systems, methods, and computer program products implemented in accordance with various embodiments disclosed herein. At this point, each box in a flowchart or block diagram can represent a module, program segment, or part of code that contains one or more executable instructions for implementing a specified logical function. It should also be noted that in some alternative implementations, the functions indicated in the box can also occur in a different order than those indicated in the accompanying drawings. For example, two consecutive boxes can actually be executed in basic parallel, and sometimes they can also be executed in opposite order, depending on the functionality involved. It should also be noted that each box in the block diagram and/or flowchart, as well as the combination of boxes in the block diagram and/or flowchart, can be implemented using dedicated hardware based systems that perform specified functions or operations, or can be implemented using a combination of dedicated hardware and computer instructions. The units described in this embodiment of the present disclosure can be implemented through software or hardware. Among them, the name of the unit does not constitute a limitation on the unit itself in a certain situation. The functions described above in this article can be at least partially executed by one or more hardware logic components. For example, nonrestrictive demonstration types of hardware logic components that can be used include: Field Programmable Gate Arrays (FPGAs), Application Specific Integrated Circuits (ASICs), Application Specific Standard Products (ASSPs), Systems on Chip (SOC), Complex Programmable Logic Devices (CPLDs), and so on.

The various components in this manual are described in a progressive manner, and the same and similar parts between each component can be referred to each other. Each component emphasizes the differences from other components. Especially for storage media and computing device embodiments, due to their basic similarity to method embodiments, the description is relatively simple. Please refer to the section on method embodiments for relevant information.

The above description is only for the better embodiments disclosed in this disclosure and an explanation of the technical principles used. Technicians in this field should understand that the scope of disclosure referred to in this disclosure is not limited to technical solutions formed by specific combinations of the aforementioned technical features and should also cover other technical solutions formed by arbitrary combinations of the aforementioned technical features or their equivalent features without departing from the disclosed concept. For example, a technical solution formed by replacing the above features with (but not limited to) technical features with similar functions disclosed in this disclosure. Furthermore, although the operations are depicted in a specific order, this should not be understood as requiring them to be executed in the specific order shown or in sequential order. In certain environments, multitasking and parallel processing may be advantageous. Similarly, although several specific implementation details are included in the above discussion, these should not be interpreted as limitations on the scope of this disclosure. Some features described in the context of individual embodiments can also be combined and implemented in a single embodiment. On the contrary, various features described in the context of a single embodiment can also be implemented individually or in any suitable sub combination in multiple embodiments.

The specific embodiments described above provide further details of the objects, technical solutions and beneficial effects of embodiments of the present invention. Although the present subject matter has been described using language specific to structural features and/or method logic actions, it should be understood that the subject matter limited in the appended claims is not necessarily limited to the specific features or actions described above. Rather, the particular features and actions described above are merely exemplary forms of implementing the claims. It should be understood that the above description is only a specific implementation of the embodiments of the present invention and is not intended to limit the scope of protection of the present invention, and any modifications, equivalent substitutions, improvements, and the like made on the basis of the technical solutions of the present invention shall be included in the scope of protection of the present invention.

1. A method of modifying a bytecode, comprising:
searching for a bytecode to be tested based on a predetermined annotation, and determining a depended object category and a depending object category for dependency injection therefrom; and
generating a supplementary bytecode based on the depended object category, inserting the supplementary bytecode into a corresponding part of the depending object category in the bytecode to be tested to obtain a target bytecode.

2. The method of claim 1, wherein the predetermined annotation comprises a first predetermined annotation and a second predetermined annotation, the first predetermined annotation being configured for labelling the depended object category, the second predetermined annotation being configured for labelling the depending object category;
the searching for a bytecode to be tested based on a predetermined annotation, and determining a depended object category and a depending object category for dependency injection therefrom comprising:
determining, based on the first predetermined annotation, a depended object category for dependency injection from a plurality of object categories comprised in the bytecode to be tested; and
determining, based on the second predetermined annotation, a depending object category for dependency injection from the plurality of object categories comprised in the bytecode to be tested.

3. The method of claim 2, wherein the predetermined annotation comprises a third predetermined annotation for labeling a member variable pointed to by the dependency injection in the dependent object category.

4. The method of claim 1, wherein the supplementary bytecode is configured for:
constructing an object instance of the depended object category and assigning the object instance to an attribute of the depending object category.

5. The method of claim 1, wherein the bytecode to be tested is obtained by compiling a target source code, which comprises an annotation corresponding to the predetermined annotation.

6. The method of claim 5, wherein an attribute of dependency injection is specified via the attribute proxy in the corresponding part of the depending object category in the target source code.

7. The method of claim 1, wherein the inserting the supplementary bytecode into a corresponding part of the depending object category in the bytecode to be tested comprising: inserting the supplementary bytecode into a constructor of the depending object category.

8. The method of claim 1, wherein the bytecode to be tested is one of JAVA bytecode or low-level virtual machine intermediate representation code (LLVM IR).

9. An electronic device comprising a memory and a processor, the memory storing an executable code therein, the executable code, when executed by the processor, implementing the acts comprising:
searching for a bytecode to be tested based on a predetermined annotation, and determining a depended object category and a depending object category for dependency injection therefrom; and
generating a supplementary bytecode based on the depended object category, inserting the supplementary bytecode into a corresponding part of the depending object category in the bytecode to be tested to obtain a target bytecode.

10. The device of claim 9, wherein the predetermined annotation comprises a first predetermined annotation and a second predetermined annotation, the first predetermined annotation being configured for labelling the depended object category, the second predetermined annotation being configured for labelling the depending object category;
the searching for a bytecode to be tested based on a predetermined annotation, and determining a depended object category and a depending object category for dependency injection therefrom comprising:
determining, based on the first predetermined annotation, a depended object category for dependency injection from a plurality of object categories comprised in the bytecode to be tested; and
determining, based on the second predetermined annotation, a depending object category for dependency injection from the plurality of object categories comprised in the bytecode to be tested.

11. The device of claim 10, wherein the predetermined annotation comprises a third predetermined annotation for labeling a member variable pointed to by the dependency injection in the dependent object category.

12. The device of claim 9, wherein the supplementary bytecode is configured for:
constructing an object instance of the depended object category and assigning the object instance to an attribute of the depending object category.

13. The device of claim 9, wherein the bytecode to be tested is obtained by compiling a target source code, which comprises an annotation corresponding to the predetermined annotation.

14. The device of claim 13, wherein an attribute of dependency injection is specified via the attribute proxy in the corresponding part of the depending object category in the target source code.

15. The device of claim 9, wherein the inserting the supplementary bytecode into a corresponding part of the depending object category in the bytecode to be tested comprising: inserting the supplementary bytecode into a constructor of the depending object category.

16. The device of claim 9, wherein the bytecode to be tested is one of JAVA bytecode or low-level virtual machine intermediate representation code (LLVM IR).

17. A non-transitory computer-readable storage medium having a computer program stored thereon, the computer program, when executed in a computer, implementing the acts comprising:
searching for a bytecode to be tested based on a predetermined annotation, and determining a depended object category and a depending object category for dependency injection therefrom; and
generating a supplementary bytecode based on the depended object category, inserting the supplementary bytecode into a corresponding part of the depending object category in the bytecode to be tested to obtain a target bytecode.

18. The medium of claim 17, wherein the predetermined annotation comprises a first predetermined annotation and a second predetermined annotation, the first predetermined annotation being configured for labelling the depended object category, the second predetermined annotation being configured for labelling the depending object category;
the searching for a bytecode to be tested based on a predetermined annotation, and determining a depended object category and a depending object category for dependency injection therefrom comprising:
determining, based on the first predetermined annotation, a depended object category for dependency injection from a plurality of object categories comprised in the bytecode to be tested; and
determining, based on the second predetermined annotation, a depending object category for dependency injection from the plurality of object categories comprised in the bytecode to be tested.

19. The medium of claim 18, wherein the predetermined annotation comprises a third predetermined annotation for labeling a member variable pointed to by the dependency injection in the dependent object category.

20. The medium of claim 17, wherein the supplementary bytecode is configured for:
constructing an object instance of the depended object category and assigning the object instance to an attribute of the depending object category.
